(19) United States
(12) Patent Application Publication
(10) Pub. No.: US 2010/0214405 A1
(43) Pub. Date: Aug. 26, 2010

(54) MICROSCOPE IMAGING SYSTEM AND METHOD FOR ITS OPERATION

(75) Inventor: Naohiro ARIGA, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/701,212

(22) Filed: Feb. 5, 2010

(30) Foreign Application Priority Data
Feb. 20, 2009 (JP) 2009-038277

(51) Int. Cl. H04N 7/18

(52) U.S. Cl. 348/79; 348/E07.085

(57) ABSTRACT

A microscope imaging system for capturing a fluorescent observation image includes: an imaging unit capturing an observed image as a colored image; a plurality of fluorescent cubes; a fluorescent cube switch unit arranging any fluorescent cube on an optical observation path by switching the plurality of fluorescent cubes; a fluorescent cube determination unit determining the fluorescent cubes arranged on the optical observation path; a gray scale adjustment unit adjusting the ratios of the color components when each pixel configuring the observed image captured by the imaging unit is converted from a color to a gray scale depending on the wavelength characteristic of the determined fluorescent cube; and a conversion unit converting each pixel configuring the observed image captured by the imaging unit from the color to the gray scale on the basis of the adjusted ratios of the color components.

### CROSS REFERENCE TO RELATED APPLICATION

This application is based on and claims the benefit of priority from the prior Japanese Patent Application No. 2009-38277 filed in Japan on Feb. 20, 2009, the entire contents of which are incorporated by this reference.

### BACKGROUND OF THE INVENTION

1. Field of the Invention

The present invention relates to a microscope imaging system configured by combining a fluorescent microscope with an imaging device.

2. Description of the Related Art

A fluorescent microscope is used in observing a fluorescence emitted from a sample by illuminating the sample with a specific wavelength band as pumping light. Generally, a plurality of fluorescent cubes are loaded onto a turret, and a fluorescent cube appropriate for a wavelength characteristic is selected to observe the fluorescence emitted from an object sample. The fluorescent observation image observed by the fluorescent microscope is captured by a camera and recorded as image data.

A plurality of portions of a sample can be observed by dyeing the sample by a plurality of fluorescent pigments and switching the fluorescent cubes. When the multiple fluorescent dyed sample is recorded as image data, the sample can be captured by a color camera or a monochrome camera. The observed image captured by the camera is transmitted as image data to a personal computer (hereinafter referred to as a PC) connected to the camera, and stored in a storage area of the PC. The observer can superpose one observed image of each fluorescent cube on another according to the image data, and display the superposed image on the display unit of the PC, or store the image data in the storage area of the PC.

Since the colors of the observed images of the respective fluorescent cubes are different from one another, the portion of each fluorescent cube can be determined although the observed images are superposed without performing image processing on the images when the observed images are captured by a color camera.

On the other hand, when the observed images are captured by a monochrome camera, the portion of each fluorescent pigment in a sample can be determined for each fluorescent cube when the observed images are superposed by assigning a false color to an observed image of each fluorescent cube.

The Japanese Laid-open Patent Publication No. 2005-331887 discloses the technology of capturing a sample multicolored by a plurality of fluorescent pigments by switching a fluorescent cube, and superposing the observed images on a display unit. The Japanese Laid-open Patent Publication No. 2008-158011 discloses the technology of converting an observed image captured by a color camera and assigning a false color to the image.

The following equation is generally used in converting a color into a gray scale (brightness value).

I=0.2989×R+0.5866×G+0.1145×B

(I: brightness value, R: intensity of red component, G: intensity of green component, B: intensity of blue component)

In the equation above, the coefficients of the R, G, and B are determined depending on the sensitivity of human eyes.

### SUMMARY OF THE INVENTION

A microscope imaging system for capturing a fluorescent observation image includes:

an imaging unit for capturing an observed image as a colored image;

a plurality of fluorescent cubes;

a fluorescent cube switch unit for arranging any fluorescent cube on an optical observation path by switching the plurality of fluorescent cubes;

a fluorescent cube determination unit for determining the fluorescent cubes arranged on the optical observation path;

a gray scale adjustment unit for adjusting the ratios of the color components when each pixel configuring the observed image captured by the imaging unit is converted from a color to a gray scale depending on the wavelength characteristic of the determined fluorescent cube; and

a conversion unit for converting each pixel configuring the observed image captured by the imaging unit from the color to the gray scale on the basis of the adjusted ratios of the color components.

In a method for operating a microscope imaging system for capturing a fluorescent observation image and including: an imaging device for capturing an observed image as a colored image; a plurality of fluorescent cubes; and a fluorescent cube switch device for arranging any fluorescent cube on an optical observation path by switching the plurality of fluorescent cubes, and determining the fluorescent cube arranged on the optical observation path, the ratios of the color components are adjusted when each pixel configuring the observed image captured by the imaging device is converted from a color to a gray scale depending on the wavelength characteristic of the fluorescent cube determined by the fluorescent cube switch device, and each pixel configuring the observed image captured by the imaging device is converted from the color to the gray scale on the basis of the adjusted ratios of the color components.

### BRIEF DESCRIPTION OF THE DRAWINGS

FIG. 1 illustrates the outline of the configuration of the fluorescent microscope system according to an embodiment of the present invention;

FIG. 2 is an example of a fluorescent cube 4;

FIG. 3 is an example of the spectral characteristic of a fluorescent cube;

FIG. 4 is an example of the spectral characteristic of an imaging device 2;

FIG. 5 illustrates a flowchart of the operation of the gray scale converting and coefficient setting process by the fluorescent microscope system; and

FIG. 6 is an example of a gray scale conversion coefficient table according to an embodiment of the present invention.

### DESCRIPTION OF THE PREFERRED EMBODIMENTS

Since the coefficient of blue is small in the conversation of the coefficients, a brightness value I becomes small when data is converted from color to gray scale especially when a fluorescence sample is observed by U pumping. Then, it is considered that the exposure time is to be increased to enhance the brightness value.

However, since the sample is exposed to pumping light for a long time, the fluorescence is faded. In addition, the ratio of noise rises by the long-time exposure.

Therefore, a method of appropriately changing the coefficients of R, G, and B is devised when an observed image is converted from color to gray scale. However, the ratio of the fluorescent color when pumping light is applied depends on the wavelength characteristic of a fluorescent pigment, and it is necessary for an observer to determine each ratio and to change the ratios of the coefficients of R, G, and B.

Accordingly, the embodiments of the present invention provide a fluorescent microscope system for adjusting the ratios of the color components when an image is converted from color to gray scale depending on the wavelength characteristic of a fluorescent cube.

The microscope imaging system according to the embodiments of the present invention can designate a fluorescent cube applied in a fluorescent observation to change the conversion coefficient for conversion from color to gray scale when an image is captured by a color camera depending on the spectral characteristic of the designated fluorescent cube.

The microscope imaging system or capturing a fluorescent observation image according to the embodiments of the present invention includes an imaging unit, a plurality of fluorescent cubes, a fluorescent cube switch unit, a fluorescent cube determination unit, a gray scale adjustment unit, and a conversion unit.

The imaging unit captures an observed image as a color image. The imaging unit corresponds to a CCD 22 and a color filter 21 in the present embodiment.

The fluorescent cube switch unit switches the plurality of fluorescent cubes and arranges any fluorescent cube on the optical observation path. The fluorescent cube switch unit corresponds to, for example, a fluorescent cube switch unit 7 according to the present embodiment.

The fluorescent cube determination unit determines the fluorescent cube arranged on the optical observation path. The fluorescent cube determination unit corresponds to, for example, the fluorescent cube switch unit 7 according to the present embodiment.

The gray scale adjustment unit adjusts the ratios of the color components when each pixel configuring the observed image captured by the imaging unit is converted from color to gray scale depending on the wavelength characteristic of the determined fluorescent cube. The gray scale adjustment unit corresponds to, for example, a PC 12 according to the present embodiment.

The conversion unit converts each pixel configuring the observed image captured by the imaging unit from color to gray scale on the basis of the adjusted ratios of the color components. The conversion unit corresponds, for example, a signal processing unit 23 according to the present embodiment.

With the above-mentioned configuration, the ratios of the color components when a conversion from color to gray scale is performed can be adjusted depending on the wavelength characteristic of the switched fluorescent cube when the fluorescent cubes are switched.

The microscope imaging system further includes a storage unit. The storage unit stores weighting information about a red component, a green component, and a blue component configuring a pixel used when each pixel configuring the observed image is converted from color to gray scale. The storage unit corresponds to, for example, a gray scale conversion coefficient table according to the present embodiment.

In this case, the gray scale adjustment unit can acquire the color component weighting information from the storage unit on the basis of the determined fluorescent cube, and set the color component weighting information for the conversion unit.

With the configuration above, a coefficient of R, G, and B can be acquired depending on the determined fluorescent cube.

Described below in detail are the embodiments of the present invention.

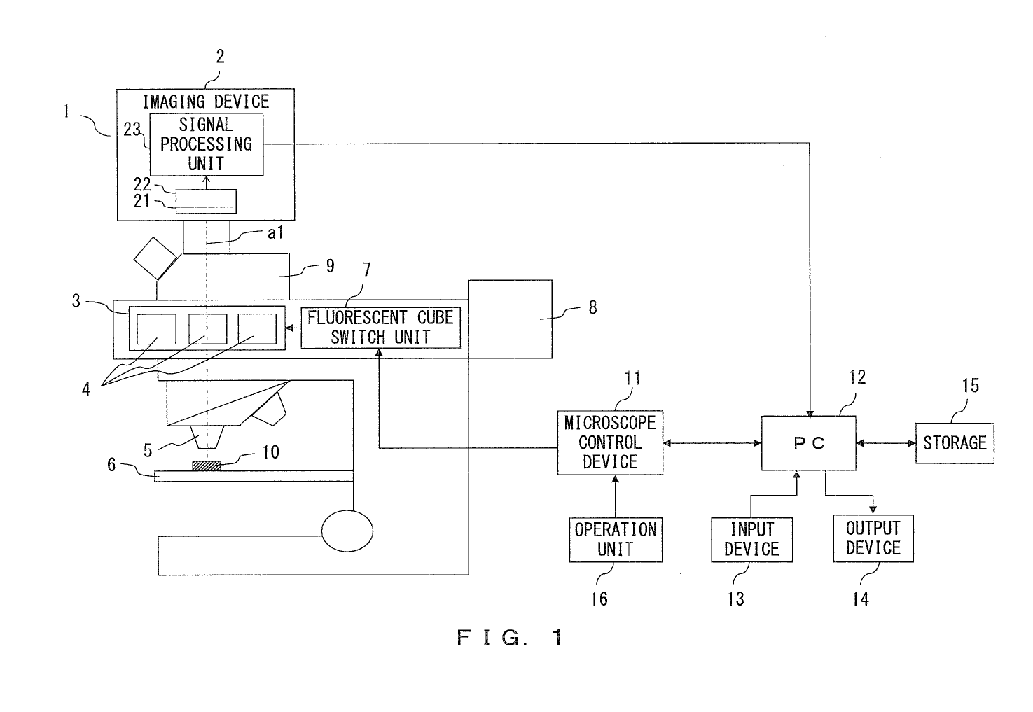

FIG. 1 illustrates the outline of the configuration of the fluorescent microscope system according to an embodiment of the present invention. A fluorescent microscope system is mainly configured by a fluorescent microscope 1, an imaging device 2, a microscope control device 11, and a PC 12.

The fluorescent microscope 1 includes a lens barrel 9, a fluorescent cube 4, a turret 3, a fluorescent cube switch unit 7, an objective 5, a stage 6, and an incident-light source 8. The stage 6 can be electrically driven horizontally and in the direction of an optical observation path al. The incident-light source 8 can be a mercury lamp etc. for emitting illumination light.

The turret 3 is loaded with a plurality of fluorescent cubes 4. The turret 3 can be rotated and arrange any fluorescent cube 4 on the optical observation path a1. The fluorescent cube switch unit 7 drives the turret 3 and switches the fluorescent cube 4.

Upon receipt of a switch instruction for the fluorescent cube 4 from the microscope control device 11, the fluorescent cube switch unit 7 switches the fluorescent cube 4. The fluorescent cube switch unit 7 can determine the type of the fluorescent cube 4.

A microscope control device 11 controls the electrically driven portion configuring fluorescent microscope 1 at an instruction of an operator through an operation unit 16. In the present embodiment, the turret 3 is rotated by, for example, controlling the drive of the fluorescent cube switch unit 7 to arrange any fluorescent cube 4 on the optical observation path a1. The operation unit 16 can be a device such as a controller, a hand switch, a mouse, a keyboard, etc. having predetermined keys arranged on them.

The fluorescent microscope 1 enables the observed image of the sample 10 placed on the stage 6 to be visually observed and led outside along the optical observation path a1. On the optical observation path a1, the imaging device 2 such as a color camera etc. is arranged in the position where the observed image from the fluorescent microscope 1 is projected.

The illumination light from the incident-light source 4 is reflected by the fluorescent cube 4, and emitted on the sample 10 through the objective 5. When the illumination light is emitted on the sample 10, pumping light is generated. The pumping light is output to the imaging device 2 as an observed image through the objective and the fluorescent cube 4.

The observed image is formed on the CCD (charge coupled device) 22 of the imaging device 2. The surface of the CCD has a plurality of image pickup elements arranged on the surface, and the color filter 21 of any of R (red), G (green), and B (blue) is arranged on each element. Each element detects the intensity of the light that has passed the color filter, and converts the detected light into an electric signal. The electric signal corresponding to each pixel is signal-processed by the signal processing unit 23. Thus, each pixel is converted into color or gray-scale data. The signal-processed image signal is transmitted as image data to the PC 12. In the present embodiment, the signal processing unit 23 signal-processes the electric signal corresponding to each pixel, and converts each pixel into gray-scale data.

The PC 12 is connected to the microscope control device 11, an input device 13, an output device 14, and storage 15. The PC 12 can control a camera 2 and the microscope control device 11 on software.

The input device 13 can be a device such as a mouse, a keyboard, etc. for operating the PC 12. By operating the input device 13, the imaging device 2 and the microscope control device 11 can be controlled on the PC 12.

The output device 14 is a display for displaying an image according to an image signal output from the PC 12. The storage 15 is an external large-capacity storage device such as a hard disk drive, DVD-R, etc. The image data transmitted from the imaging device 2 is stored in a predetermined storage device in the PC 12 or the storage 15. The image data can also be displayed on the output device 14.

An operator inputs a switch instruction of the fluorescent cube 4 using the operation unit 16. Upon receipt of a switch instruction of the fluorescent cube 4, the microscope control device 11 rotates the turret 3 and controls the fluorescent cube switch unit 7 so that the fluorescent cube 4 can be switched. The fluorescent cube switch unit 7 switches the fluorescent cube 4 at the instruction of the microscope control device 11, and determines the type of the switched fluorescent cube 4. The fluorescent cube switch unit 7 transmits the determination result to the PC 12 through the microscope control device 11.

The PC 12 acquires from the gray scale conversion coefficient table the coefficients of R, G, and B used when the signal processing unit 23 signal-processes an electric signal corresponding to each pixel output from the CCD 22 to convert each pixel of an observed image from color to gray scale depending on the spectral characteristic of the determined fluorescent cube 4. The PC 12 sets the acquired coefficients of R, G, and B in the signal processing unit 23.

The signal processing unit 23 signal-processes the electric signal corresponding to each pixel output from the CCD 22 on the basis of the set coefficients of R, G, and B, and converts each pixel of an observed image from color to gray scale. The series of processes is hereinafter referred to as a gray scale converting and coefficient setting process.

The imaging device 2 transmits the gray-scale image signal to the PC 12. The PC 12 stores the gray-scale image signal in the storage device such as ROM etc. in the PC 12 or the storage 15, or output the image to the output device 14.

Furthermore, when a multicolored fluorescent sample is observed, an observed image can be captured for each color by the imaging device 2 while switch the fluorescent cubes 4. In this case, the gray scale converting and coefficient setting process is performed depending on the switched fluorescent cube 4.

Thus, an image of each of the recorded fluorescent cubes can be superposed and stored in the storage area of the PC 12 or in the storage 15, or the superposed images can be displayed on the output device 14.

Described below in detail is the gray scale converting and coefficient setting process.

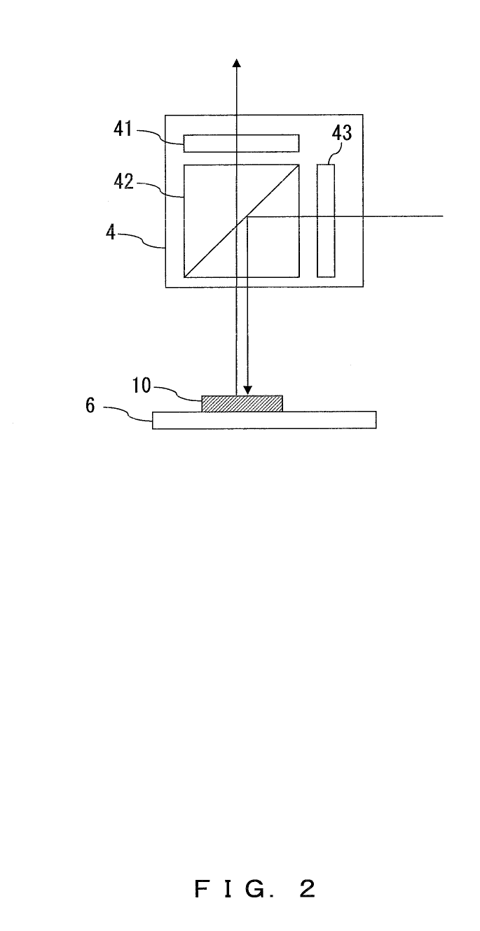

FIG. 2 is an example of the fluorescent cube 4. The fluorescent cube 4 is configured by a pumping filter 43, a dichroic mirror 42, and an absorption filter 41. Depending on the fluorescent pigment of the sample 10, the pumping filter 43, the dichroic mirror 42, and the absorption filter 41 are combined and used. Since the number of the fluorescent cubes 4 to be loaded into the fluorescent microscope 1 is limited, the operator of the fluorescent microscope 1 appropriately switches and uses the fluorescent cube 4.

In FIG. 2, when the illumination light enters the pumping filter 43, the pumping filter 43 transmits the illumination light of a predetermined wavelength component. The illumination light transmitted through the pumping filter 43 is reflected by the dichroic mirror and emitted to the sample 10. On the sample 10, the fluorescent pigments are pumped by the emitted light, and a fluorescence is emitted. The fluorescence of a predetermined wavelength component in the fluorescence emitted from the sample 10 passes through the Furthermore, in the fluorescence that has passed the dichroic mirror, the fluorescence of the predetermined wavelength component passes through the absorption filter 41.

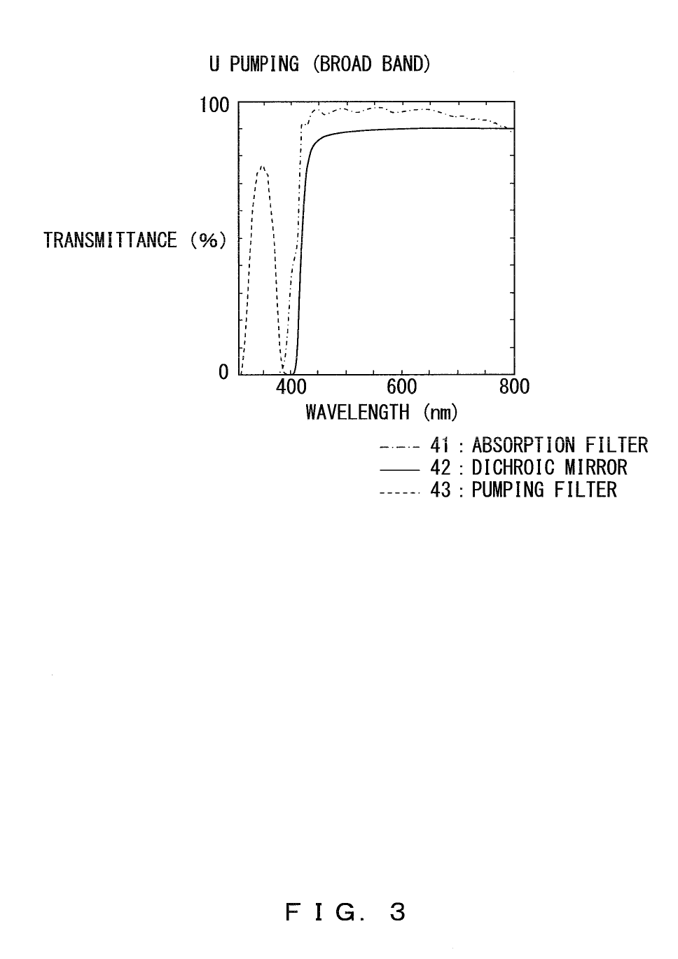

FIG. 3 is an example of the spectral characteristic of the fluorescent cube. In FIG. 3, the pumping filter 43 indicates that it passes the light of the wavelength of 300 nm through 400 nm. Each of the dichroic mirror 42 and the absorption filter 41 passes the light of the wavelength of 400 nm through 800 nm.

When the sample 10 is observed by fluorescence using the fluorescent cube 4 having the spectral characteristic illustrated in FIG. 3, the pumping light of the wavelength of 300 nm through 400 nm is emitted to the sample 10, and the fluorescence of the wavelength of 400 mm through 500 nm from the sample 10 can be observed.

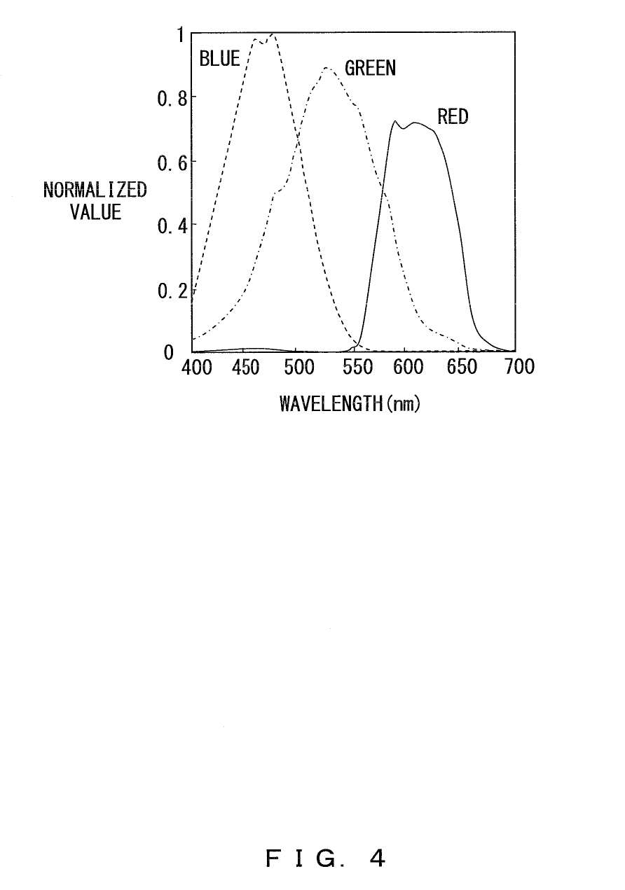

FIG. 4 is an example of the spectral characteristic of the imaging device 2. FIG. 4 illustrates the transmittance of the color filter 21 (red, green and blue filters) built in the imaging device 2. The blue filter most easily passes the light of the wavelength of 400 mm through 500 nm. The green filter most easily passes the light, of the wavelength of 500 mm through 580 nm. The red filter most easily passes the light of the wavelength of 580 mm through 650 nm.

In the present embodiment, when the sample 10 is observed using the fluorescent cube 4 and the imaging device 2, only the brightness value after the blue filter of the imaging device 2 is acquired and a gray scale image is obtained. Thus, the brightness value after the green filter and the brightness value after the red filter can be removed. As a result, the noise component other than the target color component can be removed, thereby eliminating the overlap of colors.

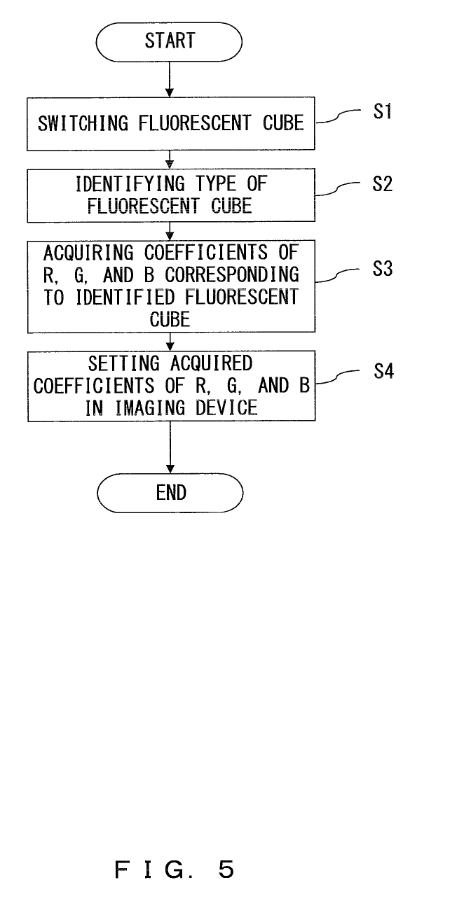

FIG. 5 illustrates a flowchart of the operation of the gray scale converting and coefficient setting process by the fluorescent microscope system. First, an operator inputs an instruction to switch the fluorescent cube 4 through the operation unit 16. At the instruction, the microscope control device 11 controls the fluorescent cube switch unit 7, and allows the fluorescent cube switch unit 7 to switch the 4 (S1).

Then, the fluorescent cube switch unit 7 determines the type of the switched fluorescent cube 4 (S2). In this case, the fluorescent cube 4 specified by the operation unit 16 can be a fluorescent cube to be determined. In addition, each fluorescent cube 4 having an ID tag embedded in advance can be read by an ID tag reader so that the fluorescent cube can be determined on the basis of the read ID. The obtained fluorescent cube determination information is transmitted to the PC 12 through the microscope control device 11.

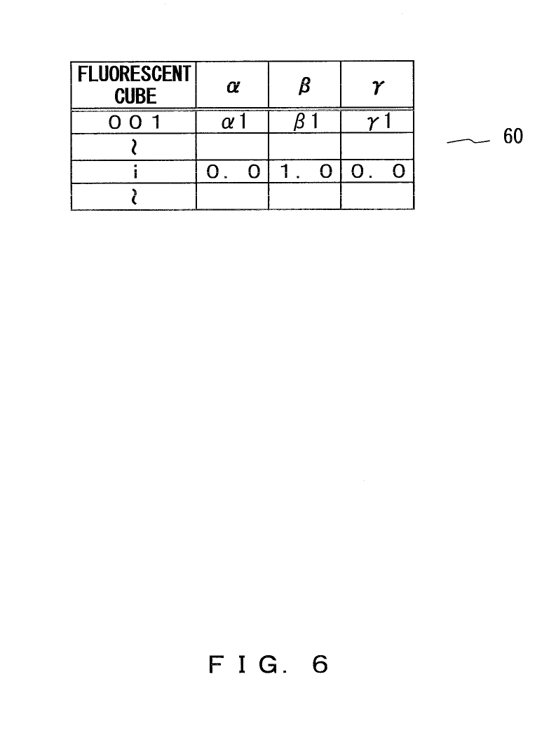

The control unit of the PC 12 acquires from the gray scale conversion coefficient table illustrated in FIG. 6 the coefficients α, β, and γ of the variables R, G, and B in the equation (1) for conversion from color to gray scale according to the received fluorescent cube determination information (S3). Described below is the equation (1).

I=α×R+β×G+γ×B (1)

(where I=gray scale value, R=brightness value when red filter is used, G=brightness value when green filter is used, B=brightness value when blue filter is used, and α, β, and γ indicate the values in the range from 0.0 to 1.0)

FIG. 6 is an example of a gray scale conversion coefficient table according to the embodiment of the present invention. The gray scale conversion coefficient table is stored in the ROM or a built-in storage device in the PC 12, or in the storage 15.

The gray scale conversion coefficient table is configured by the data items of a “fluorescent cube”, “α”, “β”, and “γ”. The data item “fluorescent cube” stores the fluorescent cube determination information. The data items “α”, “β”, and “γ” respectively stores the coefficients of R, G, and B in the equation (1) of the fluorescent cube corresponding to the fluorescent determination information stored in the same record.

Described below is the method of setting the coefficients α, β, and γ of R, G, and B. The coefficient of the color closest to the wavelength when the transmittances of the dichroic mirror 42 in the fluorescent cube 4 and the absorption filter 41 are about 100% is set to 1, and other coefficients are set to 0.

For example, in the spectral characteristic of the fluorescent cube 4 illustrated in FIG. 3, the transmittances of the dichroic mirror 42 and the pumping filter 43 are about 100% from 400 nm. Therefore, the coefficient γ of B is set to 1.0, and the coefficients α and β of R and G are set to 0.0.

In addition, for example, when the transmittances of the dichroic mirror 42 and the absorption filter 41 of the fluorescent cube 4 are about 100% from 500 nm, the coefficient β of G is set to 1.0, and the coefficients α and γ of R and B are set to 0.0.

Additionally, for example, when the transmittances of the dichroic mirror 42 and the absorption filter 41 of the fluorescent cube 4 are about 100% from 600 nm through, the coefficient α of R is set to 1.0, and the coefficients β and γ of G and B are set to 0.0.

Furthermore, for example, when the transmittances of the dichroic mirror 42 and the absorption filter 41 of the fluorescent cube 4 are about 100% from 450 nm, the coefficient β of G is set tot1.0, and the coefficients α and γ of R and B are set to 0.0.

Thus, the relationship between the wavelength with which the transmittances of the dichroic mirror 42 and the absorption filter of the fluorescent cube 4 are about 100 and the coefficients α, β, and γ of R, G, and B is summarized in Table 1 below.

| | WAVELENGTH WITH WHICH | | | |
|---|---|---|---|---|
| | TRANSMITTANCES OF | | | |
| | DICHROIC MIRROR 42 | | | |
| | AND ABSORPTION FILTER | SET VALUE OF | SET VALUE OF | SET VALUE OF |
| | OF FLUORESCENT CUBE | COEFFICIENT | COEFFICIENT | COEFFICIENT |
| | 4 ARE ABOUT 100 | α OF R | β OF G | γ OF B |
| 1 | 400[nm] | 0.0 | 0.0 | 1.0 |
| 2 | 450[nm] | 0.0 | 1.0 | 1.0 |
| 3 | 500[nm] | 0.0 | 1.0 | 0.0 |
| 4 | 550[nm] | 1.0 | 1.0 | 0.0 |
| 5 | 600[nm] | 1.0 | 0.0 | 0.0 |

Thus, on the gray scale conversion coefficient table, the values of the coefficients α, β, and γ of R, G, and B are set for each fluorescent cube.

Upon receipt of the fluorescent cube determination information from the fluorescent cube switch unit 7, the control unit of the PC 12 extracts the record matching the fluorescent cube determination information from the gray scale conversion coefficient table, and acquires the values of α, β, and γ included in the record.

The control unit of the PC 12 sets the acquired values of the coefficients α, β, and γ of R, G, and B in the signal processing unit 23 (S4). The signal processing unit 23 signal-processes the electric signal corresponding to each pixel output from the CCD 22 by the equation (1) on the basis of the set values of α, β, and γ, and expresses each pixel as gray scale data. The gray-scale image signal is transmitted to the PC 12.

The PC 12 stores the gray-scale image signal in the ROM or the built-in storage device in the PC 12 or the storage 15 or displays the signal on the output device 14 as a display unit.

According to the present embodiment, the setting of a computer can be changed when a gray-scale image is generated depending on the type of the fluorescent cube 4 placed on the optical observation path a1 using the imaging device 2 in the microscope imaging system configured by combining a fluorescent microscope and an imaging device.

### Variation Example 1

In the embodiment above, the fluorescent cube 4 is switched by the operation unit 16 in S1. However, the present invention is not limited to the application above, but the fluorescent cube 4 can be switched by a predetermined program. For example, the fluorescent cube 4 can be switched after a predetermined elapsed time, and the gray scale converting and coefficient setting process is performed each time the fluorescent cube is switched to acquire an observed image.

### Variation Example 2

With the configuration above, the fluorescent cube 4 is switched under electric control, and the type of the fluorescent cube 4 is designated. However, the present invention is not limited to this application. For example, the fluorescent cube can be manually switched, the fluorescent cube provided with an IC tag is read by an IC tag reader, and the type of the fluorescent cube can be designated.

### Variation Example 3

In the embodiment above, the PC 12 stores an image captured by the imaging device 2, and controls the imaging device 2. However, the present invention is not limited to this process, but a control device for the imaging device 2 can be provided. Using the control device for the imaging device 2, the image data can be recorded or the imaging device 2 can be controlled without using the PC 12.

### Variation Example 4

In the embodiment above, the coefficients α, β, and γ of R, G, and B of the equation (1) are equally set to 1.0, but the present invention is not limited to this value. For example, as listed in Table 2, the coefficients can be adjusted so that the sum of the coefficients of R, G, and B can be 1.0.

| | WAVELENGTH WITH WHICH | | | |
|---|---|---|---|---|
| | TRANSMITTANCES OF | | | |
| | DICHROIC MIRROR 42 | | | |
| | AND ABSORPTION FILTER | SET VALUE OF | SET VALUE OF | SET VALUE OF |
| | OF FLUORESCENT CUBE | COEFFICIENT | COEFFICIENT | COEFFICIENT |
| | 4 ARE ABOUT 100 | α OF R | β OF G | γ OF B |
| 1 | 400[nm] | 0.0 | 0.0 | 1.0 |
| 2 | 450[nm] | 0.0 | 0.5 | 0.5 |
| 3 | 500[nm] | 0.0 | 1.0 | 0.0 |
| 4 | 550[nm] | 0.5 | 0.5 | 0.0 |
| 5 | 600[nm] | 1.0 | 0.0 | 0.0 |

In addition, according to the present embodiment, an instruction to switch the fluorescent cube can be issued using the operation unit 16, but an instruction to switch the fluorescent cube can also be issued using the input device 13 through the PC 12. In addition, the fluorescent cube switch unit has the functions of arranging any fluorescent cube on the optical observation path by switching the fluorescent cube, and determining the fluorescent cube arranged on the optical observation path, but the present invention is not limited to these functions. For example, another device (for example, an ID tag reader etc.) having the function of determining the fluorescent cube arranged on the optical observation path can also be provided.

In the present embodiment, the ratios of the color components for conversion from color to gray scale is changed on the basis of the wavelength characteristic of the fluorescent cube depending on the switch of the fluorescent cube 4 in the present embodiment. However, the present invention is not limited to this application, but the exposure time, the white balance, the black balance and the ISO sensitivity of a camera can be changed depending on the switch of the fluorescent cube 4. For example, the exposure time of the camera corresponding to the wavelength characteristic of each fluorescent cube can be stored on a table, and the exposure time is acquired from the table depending on the determined fluorescent cube 4 so that the acquired exposure time can be set in the imaging device 2. In addition, the white balance or the black balance corresponding to the wavelength characteristic of each fluorescent cube can be stored on a table, the white balance or the black balance can be acquired from the table depending on the determined fluorescent cube 4, and the acquired white balance or black balance can be set in the imaging device 2. Furthermore, the ISO sensitivity corresponding to the wavelength characteristic of each fluorescent cube can be stored on a table, the ISO sensitivity can be acquired from the table depending on the determined fluorescent cube 4, and the acquired ISO sensitivity can be set in the imaging device 2.

According to the present invention, the ratios of the color component for conversion from color to gray scale can be changed on the observed image captured by an imaging device depending on the spectral characteristic of the fluorescent cube set in a fluorescent microscope. Thus, the optimum image without an unintentional overlap of colors or background current noise by an unnecessary color filter of an imaging device can be acquired.

The present invention is not limited to the above-mentioned embodiments, but can be realized by various configurations or embodiments within the gist of the present invention.

What is claimed is:

1. A microscope imaging system for capturing a fluorescent observation image, comprising:
an imaging unit capturing an observed image as a colored image;
a plurality of fluorescent cubes;
a fluorescent cube switch unit arranging any fluorescent cube on an optical observation path by switching the plurality of fluorescent cubes;
a fluorescent cube determination unit determining the fluorescent cubes arranged on the optical observation path;
a gray scale adjustment unit adjusting ratios of color components when each pixel configuring the observed image captured by the imaging unit is converted from a color to a gray scale depending on a wavelength characteristic of the determined fluorescent cube; and
a conversion unit converting each pixel configuring the observed image captured by the imaging unit from the color to the gray scale on a basis of the adjusted ratios of the color components.

2. The microscope imaging system according to claim 1, further comprising:
a storage unit storing weighting information about a red component, a green component, and a blue component configuring a pixel used when each pixel configuring the observed image is converted from a color to a gray scale corresponding to each fluorescent cube, wherein
the gray scale adjustment unit acquires the color component weighting information from the storage unit on a basis of the determined fluorescent cube, and sets the color component weighting information in the conversion unit.

3. A method for operating a microscope imaging system for capturing a fluorescent observation image, comprising:
an imaging device capturing an observed image as a colored image;
a plurality of fluorescent cubes; and
a fluorescent cube switch device arranging any fluorescent cube on an optical observation path by switching the plurality of fluorescent cubes, and determining the fluorescent cube arranged on the optical observation path, wherein:
ratios of color components are adjusted when each pixel configuring the observed image captured by the imaging device is converted from a color to a gray scale depending on a wavelength characteristic of the fluorescent cube determined by the fluorescent cube switch device; and
each pixel configuring the observed image captured by the imaging device is converted from the color to the gray scale on the basis of the adjusted ratios of the color components.
